(19) United States
(12) Patent Application Publication
(10) Pub. No.: US 2006/0259233 A1
(43) Pub. Date: Nov. 16, 2006

(54) Road precursory and vehicle trip recording method of navigation system

(75) Inventors: Chang-Chun Chien, Taipei County (TW); Ping-Huei Shu, Hsinchu County (TW); Li-Kung Huang, Taipei County (TW); Long-Tai Chen, Miaoli County (TW)

Correspondence Address: BACON & THOMAS, PLLC, 625 SLATERS LANE, FOURTH FLOOR, ALEXANDRIA, VA, 22314, US

(73) Assignee: INDUSTRIAL TECHNOLOGY RESEARCH INSTITUTE, HSINCHU HSIEN (TW)

(21) Appl. No.: 11/126,241

(22) Filed: May 11, 2005

(51) Int. Cl. G01C 21/00

(52) U.S. Cl. 701/200; 701/93; 701/213

(57) ABSTRACT

A road precursory and vehicle trip recording method of a navigation system employs a GPS and an inertial measurer to access respectively the present coordinate point and driving direction of the car in an electronic map, defines a comparative coordinate point by using an estimated distance before the present coordinate point of the vehicle, and compares the present speed of the vehicle with a predetermined safety vehicle speed of the comparative coordinate point set in an electronic map so as to transmit precursory signals once the present speed of the vehicle exceeds the predetermined safety vehicle speed, thereby preventing the vehicle driver from danger resulted from fatigue or carelessness. In addition, the actual speed, the turning angle of the steering wheel, and the GPS coordinate points and time will be fully recorded during driving.

### BACKGROUND OF THE INVENTION

1. Field of the Invention

The present invention relates to a navigation system and more specifically, to a road precursory and vehicle trip recording method of a navigation system.

2. Description of the Related Art

In traffic transportation, more and more users rely upon a navigation system to guide the route and locations. Early navigation systems provide road information by means of images without giving a guide to the conditions of front roads. These navigation systems simply provide information related to the driving direction, having little navigation value.

Recently, new navigation systems provide improved functions, giving sufficient information about the conditions of front roads. For example, an advanced navigation system can provide a guide to legal limit vehicle speed, picking up the images of the intersection of front roads and displaying the images in an enlarged scale, giving a signal of approaching of the car to a front road turn and a speed limit under the condition of such a front road turn. U.S. Pat. No. 5,315,295 discloses a vehicle speed control system, which calculates a limit vehicle speed, at which the vehicle can negotiate and pass safely through the curve, based on the information of the vehicle speed and the radius of curvature of the curve obtained from a variety of sensors. When the vehicle speed is higher than the limit vehicle speed, the vehicle speed control system provides a warning and/or automatically brakes the vehicle, or automatically closes a throttle of the vehicle, so as to lower the vehicle speed below the limit vehicle speed. This real-time calculation will provide a wrong limit vehicle speed if one of the sensors fails. Providing the car driver with wrong information may result in a traffic accident. Because of imperfect calculation method, the aforesaid system runs risks.

Further, current navigation systems provide sufficient information related to front side services such as vehicle traveling direction and vehicle speed limit, however the information related to rear side services is insufficient.

### SUMMARY OF THE INVENTION

The present invention has been accomplished under the circumstances in view. It is the primary objective of the present invention to provide a road precursory and vehicle trip recording method for a navigation system, which prevents the navigation system from running risks.

It is another objective of the present invention to provide a road precursory and vehicle trip recording method for a navigation system, which provides driving records for tracing the traveled trips or judging the situation in case of a traffic accident.

To achieve these objectives of the present invention, the road precursory and vehicle trip recording method of the present invention employs a GPS and an inertial measurer to access respectively the present coordinate point and driving direction of the car in an electronic map, defines a comparative coordinate point by using an estimated distance before the present coordinate point of the vehicle, and compares the present speed of the vehicle with a predetermined safety vehicle speed of the comparative coordinate point set in an electronic map so as to transmit precursory signals once the present speed of the car exceeds the safety speed, thereby preventing the vehicle driver from danger resulted from fatigue or carelessness. In addition, the actual speed, the turning angle of the steering wheel, and the GPS coordinate points and time will be fully recorded during driving.

### BRIEF DESCRIPTION OF THE DRAWINGS

FIG. 1 is a flow chart of a road precursory and vehicle trip recording method according to the present invention.

FIG. 2A is a schematic drawing of a single curve according to the present invention.

FIG. 2B is a schematic drawing of a multi-curve according to the present invention.

FIG. 2C is a schematic drawing of a reverse curve according to the present invention.

FIG. 3 is a table of coordinate points at selected road sections within the electronic map data according to the present invention.

FIG. 4 is a schematic drawing showing the contained angle between the present traveling line and the estimated traveling route according to the present invention.

FIG. 5 is a comparison table between the present vehicle speed and vehicle moving direction δθ according to the present invention.

FIG. 6 is a comparison table between the present vehicle speed and vehicle moving direction −δθ according to the present invention.

FIG. 7 is a comparison table between the present vehicle speed and the R value of vehicle moving direction according to the present invention.

FIG. 8 corresponds to FIG. 3 after input of estimated safety vehicle speed.

### DETAILED DESCRIPTION OF THE INVENTION

A road precursory and vehicle trip recording method in accordance with the present invention includes two parts, namely the road precursory procedure and the vehicle traveling recording procedure.

The road precursory procedure includes steps 1 through 7. The first step is to establish an electronic map data, which includes the sub-steps of:

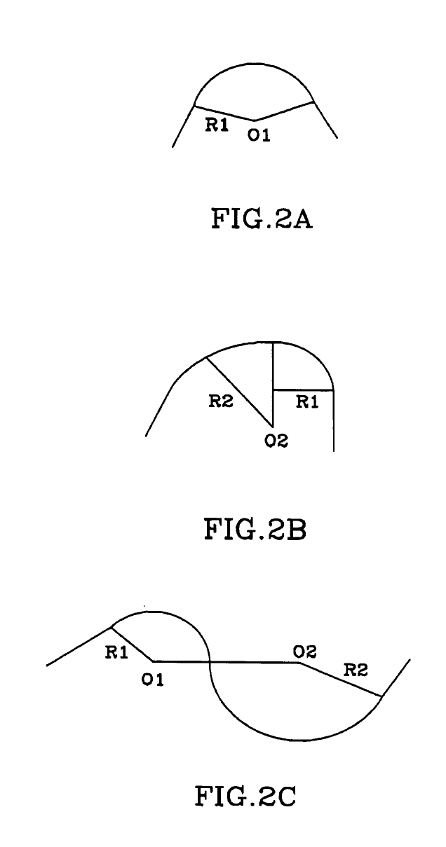

(a) defining all the roads in the electronic map to be a combination of a single curve as shown in FIG. 2A, a multi-curve as shown in FIG. 2B, or a reverse curve as shown in FIG. 2C;

(b) defining the weight of the vehicle, and defining the average outer line elevation of the roads on every coordinate point and road surface μ value subject to road construction design regulations;

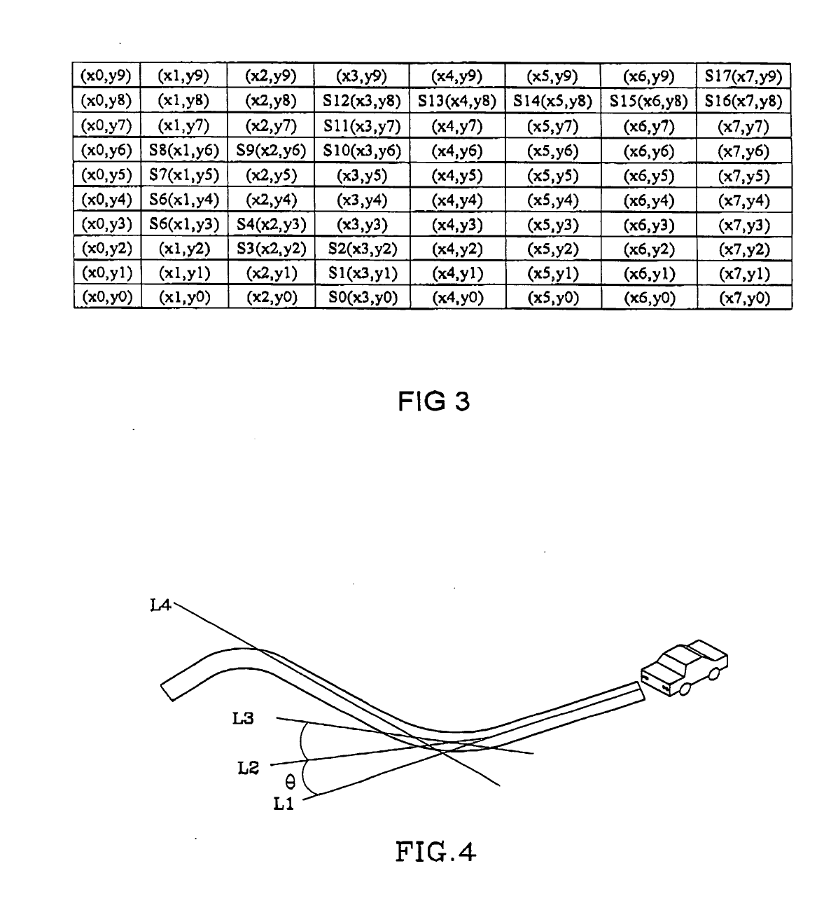

(c) selecting a number of points from every road in the electronic map, for example, selecting 18 points from the example road section as shown in FIG. 3, i.e., S₀ through S₁₇, and then calculating the contained angle of two adjacent traveling right lines subject to the aforesaid combination of curves as shown in FIG. 4; for example, L1 is the equation of the line from S₀(X₀, Y₀) to S₁(X₁, Y₁) where the pitch between the two points is 15″ (1″ is a longitude/latitude unit, 1″=31.0281 meters), L2 is the equation of the line from S₁(X₁, Y₁) to S₂(X₂, Y₂), and the contained angle θ between L1 and L2 is calculated by means of mathematic equation; and the contained angle θ between L2 and L3 and the contained angle θ between L3 and L4 and etc. are calculated in the same way;

(d) selecting three points S₀(X₀, Y₀), S₁(X₁, Y₁), S₂(X₂, Y₂) from the aforesaid combination of curves where the distance between every two points is 15″ (1″ is a longitude/latitude unit, 1″=31.0281 meters), and then calculating the equation of the route y=f(x), so as to obtain:

$$curvature ρ ( X , Y ) = \vert \frac{{[ 1 + {( \frac{ⅆ y}{ⅆ x} )}^{2} ]}^{\frac{3}{2}}}{\frac{{ⅆ}^{2} y}{ⅆ {x}^{2}}} \vert$$

and then using increasing interval (f′(x)>0) to calculate range value of x; decreasing interval (f′(x)<0) to calculate range value of x; upward concave interval (f″(x)>0) to calculate range value of x; downward concave interval (f″(x)<0) to calculate range value of x; inflection point (f″(x)=0) to calculate value of x; i.e., the radius of curve at every coordinate point to be:
R=ρ(Xₙ, Yₙ)

(e) employing dynamic expression to calculate the safety vehicle speed value V_{S1}=f(θ) by estimating dynamic balance of the vehicle in turning subject to variation of θ by combining road average outer line elevation, road surface μ value and vehicle weight, such safety vehicle speed value is to consider the effect of angular momentum to the vehicle on the curved road, preventing turnover of the vehicle;

(f) employing dynamic expression to calculate the safety vehicle speed value V_{S2}=f(R) by estimating dynamic balance of the vehicle in turning subject to curved road R value by combining road average outer line elevation, road surface μ value and vehicle weight, such safety vehicle speed value is to consider the effect of centrifugal force to the vehicle on the curved road, preventing deviation of the vehicle from the road;

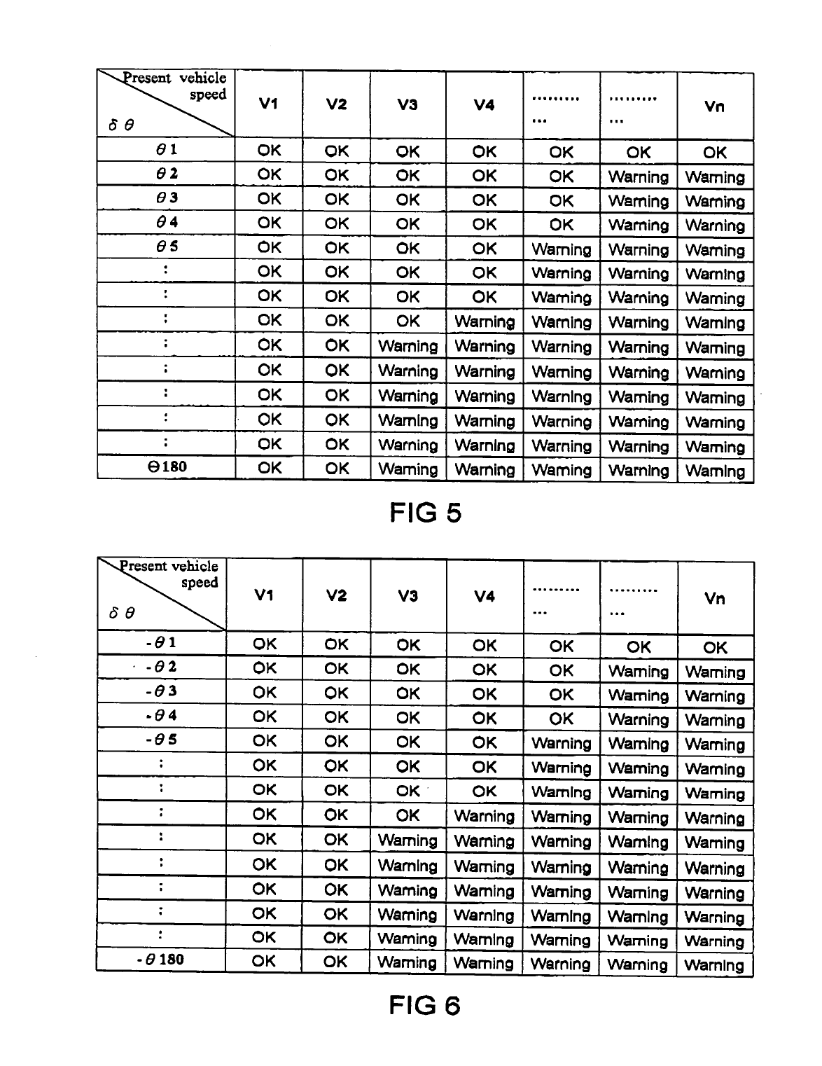

(g) establishing θ value-related safety vehicle speed comparison table as shown in FIGS. 5 and 6;

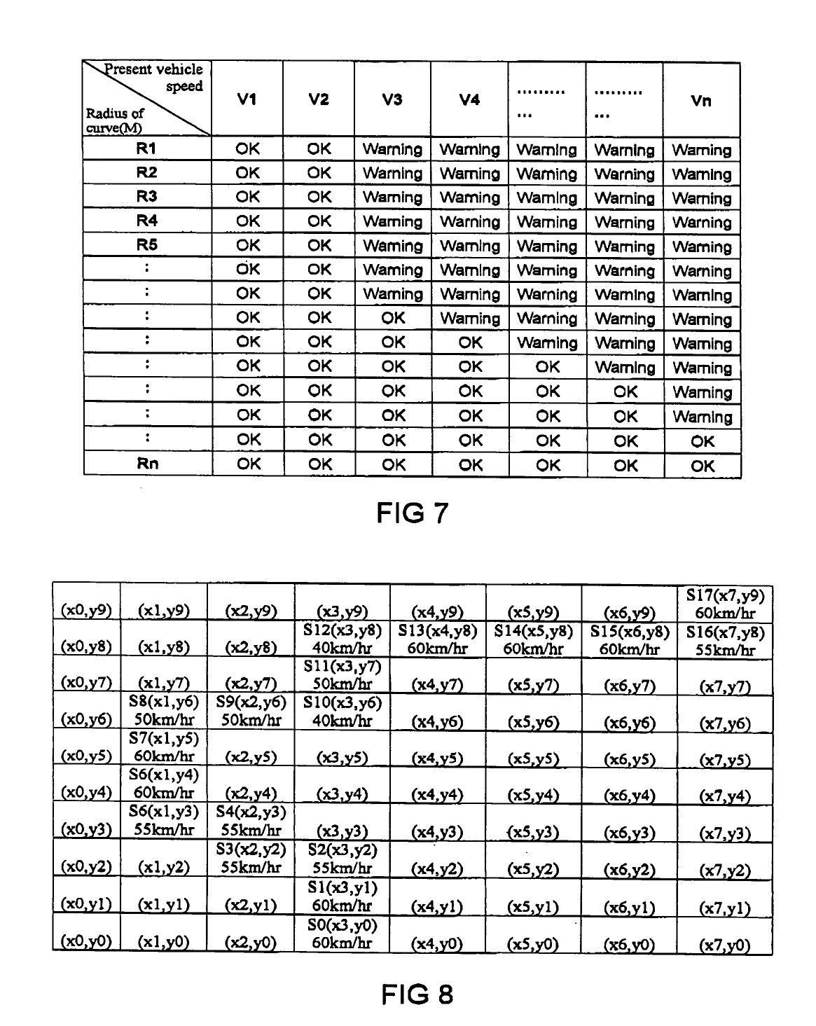

(h) establishing R value-related safety vehicle speed comparison table as shown in FIG. 7;

(i) selecting the lower safety vehicle speed value from (g) and (h) as the standard safety vehicle speed value for every coordinate point, i.e., standard vehicle speed value V_{S}=Min(V_{S1}, V_{S2}), and then gathering the data thus obtained into the electronic map data of the satellite navigation system. As shown in FIG. 8, the respective standard safety vehicle speeds for the 18 points at the example road section are established, for example, the standard safety vehicle speed for the straight road section S₀-S₁ to be 60 Km/hr, the standard safety vehicle speed for the curved road section S₂-S₆ to be 55 Km/hr, the standard safety vehicle speed for the continuously curved road section S₁₀-S₁₂ to be 40 Km/hr.

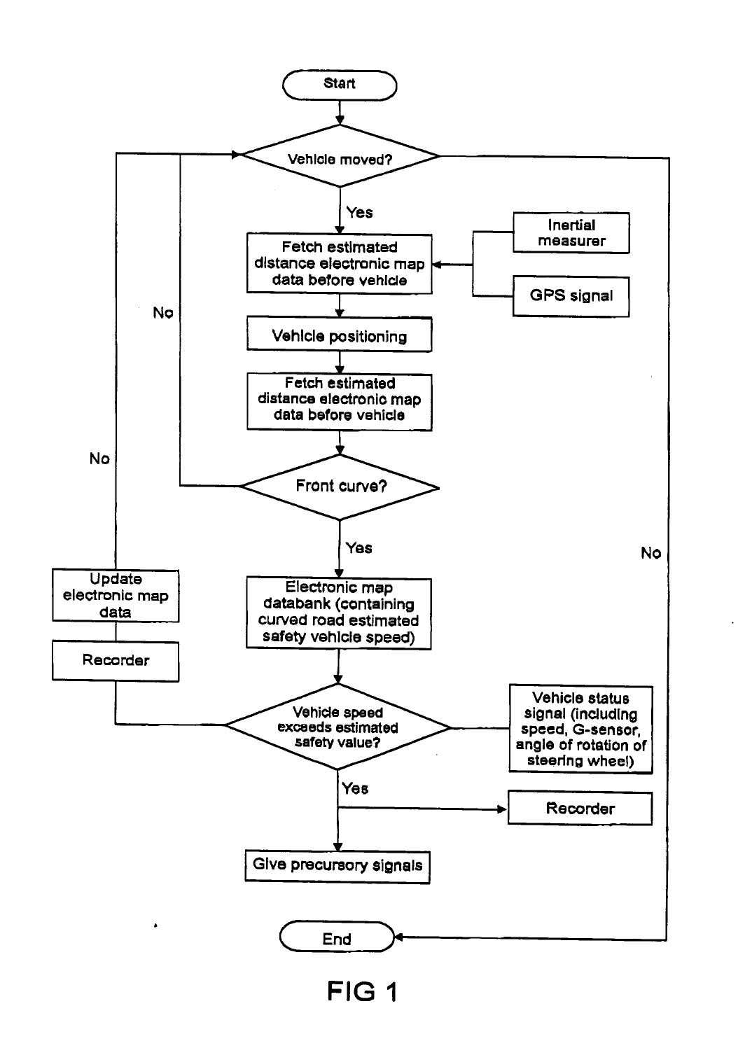

Referring to FIG. 1, the second step of the road precursory procedure is to fetch the present coordinate position of the vehicle from GPS positioning data and to detect movement of the vehicle.

The third step of the road precursory procedure is to establish in the vehicle an inertial measurer and a planar rectangular coordinate system (global longitude/latitude coordinate system) and to use the inertial measurer and the rectangular coordinate system to detect the direction of the vehicle during its movement. The inertial measurer is an angular momentum measuring instrument, for example, gyroscope.

The fourth step of the road precursory procedure is to define a distance before the present coordinate point of the vehicle as an estimated distance and to pick up the comparative coordinate point of the estimated distance. The estimated distance can be defined by a fixed mode, or alternatively by a variable mode. When the fixed mode is adopted, the estimated distance is defined to be 100 km for example. When the variable mode is adopted, the estimated distance is defined to be, for example, 10 times of the length of the vehicle when the present vehicle speed is 100 km/hr or, 5 times of the length of the vehicle when the present vehicle speed is 50 km/hr. On other words, calculate the estimated distance subject to the present vehicle speed, and add one unit of the length of the vehicle each time the vehicle speed is increased by 10 km/hr.

The fifth step of the road precursory procedure is to establish in the vehicle a vehicle speed sensor, a G-sensor and a steering wheel bevel scale, and to use the vehicle speed sensor, the G-sensor and the steering wheel bevel scale to detect the present vehicle speed, G-sensor value and angle of rotation of the steering wheel of the vehicle so as to obtain the respective vehicle speed signal and the G-sensor signal and the steering wheel position signal.

The sixth step of the road precursory procedure is to compares the present vehicle speed with the estimated safety vehicle speed in the electronic map data, i.e., to compare the value of the present vehicle speed with the value of the standard safety vehicle speed for the comparative coordinate point of the estimated distance.

The seventh step of the road precursory procedure is to give a warning signal once the present vehicle speed exceeds the standard safety vehicle speed. If the speed of the vehicle exceeds the standard safety vehicle speed and the vehicle does not cause any traffic accident when reached the comparative coordinate point, the electronic map data will automatically update the value of the standard safety vehicle speed for reference in next trip.

Further, the vehicle trip recording procedure of the road precursory and vehicle trip recording method is to establish in the vehicle a vehicle speed sensor, a G-sensor, a steering wheel bevel scale, and a GPS (Global Positioning System), and to use the installed devices to record the data of the actual speed of the vehicle, the angle of rotation of the steering wheel of the vehicle, the G-sensor value, and the GSP coordinate points and time. Because the recorded data is presented in the form of numerals, it does not use much memory space. In consideration of memory space, the data can be stored in the memory by covering the old data with the new data after a predetermined length of time in storage or after occupation of a segment of memory space.

Actually, the vehicle trip recording procedure of the road precursory and vehicle trip recording method of the present invention provides a great contribution to rear side services related to the traveling of the vehicle. For example, when a traffic accident occurred, the recorded vehicle speed data, rotary angle data of the steering wheel, G-sensor data and the data of GSP coordinate points and time can be inputted into an apparatus capable of reading the data, for example, notebook computer or PDA, for reading the status of the vehicle and the operating status of the driver of the vehicle during the period the traffic accident occurred. Alternatively, the recorded vehicle speed data, rotary angle data of the steering wheel, G-sensor data and the data of GSP coordinate points and time can be inputted into an apparatus carrying an electronic map, for example, notebook computer or PDA, for simulating the traffic route the vehicle passed and the status of the vehicle during the period the traffic accident occurred. On other words, the related traveling records of the navigation system according to the present invention provides traveled route data, vehicle status data and the data of the operating status of the driver of the vehicle indirectly that are valuable reference data for traffic accident examination, criminal case handling, or tracing of vehicle trips.

Therefore, with respect to road precursory procedure, the invention combines the value of the standard safety vehicle speed for every coordinate point into the electronic map data in the satellite navigation system, eliminating the risk of providing a wrong safety vehicle speed value resulted from failure of the sensors or wrong real-time messages. Further, the calculation of the standard safety vehicle speed has considered the R value-related safety speed limit and the θ value-related safety speed limit, thereby providing a better safety coefficient. Further, the invention provides a self-update function to update the data. Comparing to conventional navigation systems, the invention provides multiple functions. With respect to vehicle trip recording procedure, the invention records the data of the actual speed of the vehicle, the rotary angle of the steering wheel of the vehicle, the G-sensor value, and the GSP coordinate points and time for reference, and the recorded data gives a great contribution to rear side services related to the traveling of the vehicle.

What is claimed is:

1. A road precursory method used in a navigation system in a vehicle, comprising the steps of:
(a) employing a GPS and an inertial measurer to access respectively the present coordinate point and driving direction of the vehicle;
(b) defining a comparative coordinate point by using an estimated distance before the present coordinate point of the vehicle, and
(c) comparing the present speed of the vehicle of the present coordinate point with a predetermined safety vehicle speed of the comparative coordinate point set in an electronic map so as to transmit precursory signals once the present speed of the vehicle exceeds said predetermined safety vehicle speed.

2. The road precursory method as claimed in claim 1, wherein said predetermined safety vehicle speed is obtained by calculating the contained angle θ of two adjacent traveling right lines by means of using mathematic equation to estimate dynamic balance of the vehicle on a curved road.

3. The road precursory method as claimed in claim 1, wherein said predetermined safety vehicle speed is obtained by means of using mathematic equation to estimate dynamic balance of the vehicle on a curved road and by selecting the coordinate values of three points from a combination of curved roads and then calculating the equation of the route y=f(x), so as to obtain:
$$curvature ρ ( X , Y ) = \vert \frac{{[ 1 + {( \frac{ⅆ y}{ⅆ x} )}^{2} ]}^{\frac{3}{2}}}{\frac{{ⅆ}^{2} y}{ⅆ {x}^{2}}} \vert$$
and the radius of curve at every coordinate R=ρ(Xₙ, Yₙ).

4. The road precursory method as claimed in claim 1, wherein said predetermined safety vehicle speed is obtained by: calculating the contained angle θ of two adjacent traveling right lines by means of using mathematic equation to estimate dynamic balance of the vehicle on a curved and then to calculate the safety vehicle speed value V_{S1}=f(θ), and selecting the coordinate values of three points from a combination of curved roads and then calculating the equation of the route y=f(x), so as to obtain:
$$curvature ρ ( X , Y ) = \vert \frac{{[ 1 + {( \frac{ⅆ y}{ⅆ x} )}^{2} ]}^{\frac{3}{2}}}{\frac{{ⅆ}^{2} y}{ⅆ {x}^{2}}} \vert$$
and the radius of curve at every coordinate R=ρ(Xₙ, Yₙ) and then employing dynamic expression to estimate the safety vehicle speed value V_{S2}=f(R) so as to obtain the predetermined safety vehicle speed value V_{S}=Min(V_{S1}, V_{S2}).

5. The road precursory method as claimed in claim 1, wherein said estimated distance defined in the step (b) is defined by a fixed mode.

6. The road precursory method as claimed in claim 1, wherein said estimated distance defined in the step (b) is defined by a variable mode.

7. The road precursory method as claimed in claim 6, wherein said variable mode is to calculate the estimated distance subject to the present vehicle speed, and add one unit of the length of the vehicle each time the vehicle speed is increased by 10 km/hr.

8. The road precursory method as claimed in claim 1, further comprising the step of (d) updating the value of the safety vehicle speed recorded in the electronic map data for reference in next trip if the speed of the vehicle exceeds the predetermined safety vehicle speed and the vehicle does not cause any traffic accident when reached the comparative coordinate point.

9. The road precursory method as claimed in claim 1, wherein the vehicle is equipped with a vehicle speed sensor, a G-sensor and a steering wheel bevel scale so as to detect and record the GSP coordinate points and time, the actual vehicle speed, G-sensor value and angle of rotation of the steering wheel of the vehicle during the traveling of the vehicle.

10. A vehicle trip recording method used in a navigation system in a vehicle, comprising the step of establishing in the vehicle a vehicle speed sensor, a G-sensor, a steering wheel bevel scale, and a GPS (Global Positioning System), and the step of recording the data of the actual speed of the vehicle, the angle of rotation of the steering wheel of the vehicle, the G-sensor value, and the GSP coordinate points and time, which are respectively detected by the vehicle speed sensor, the G-sensor, the steering wheel bevel scale and the GPS, during the traveling of the vehicle.
